(19) United States
(12) Patent Application Publication
(10) Pub. No.: US 2023/0222006 A1
(43) Pub. Date: Jul. 13, 2023

(54) Container Orchestration System

(71) Applicant: Telefonaktiebolaget LM Ericsson (publ), Stockholm (SE)

(72) Inventor: Zhongwen Zhu, Saint-Laurent (CA)

(21) Appl. No.: 18/009,801

(22) PCT Filed: Jun. 12, 2020
(86) PCT No.: PCT/IB2020/055552

§ 371 Date: Dec. 12, 2022

(51) Int. Cl. G06F 9/50

(52) U.S. Cl. CPC G06F 9/5077; G06F 2209/5011; G06F 2209/505

(57) ABSTRACT

The present disclosure provides a system for coordinating the distribution of resource instances (e.g. Kubernetes nodes) that belong to different infrastructure providers providing resource instances at different locations. Each infrastructure provider provides one or more resource instances. The resource instances provide by an infrastructure can be spread over multiple locations. Several Kubernetes master nodes are deployed to manage the RIs spread among multiple infrastructure providers and multiple locations.

### TECHNICAL FIELD

The present disclosure relates generally to a container orchestration and, more particular, to an orchestration system that manages containers deployed on network infrastructures provided by multiple infrastructure providers.

### BACKGROUND

A container is a technology for packaging application code along with any required dependencies that the application requires at run time. Containers facilitate application deployment, scaling and management across a plurality of hosts. In the context of communication networks, various network functions in the communication network can be implemented as applications running in containers. Due to its simplicity, lightweight footprint, and efficiency, the use of containers is gaining momentum in communication networks and may soon surpass the more traditional Network Function Virtualization (NFV) approach.

Kubernetes, commonly referred to as K8, is an open source container orchestration system or platform for automating application deployment, scaling and management across a plurality of hosts, which can be either physical computers or Virtual Machines (VMs). Kubernetes creates an abstraction layer on top of a group of hosts that makes it easier to deploy application containers while allowing the orchestration system to manage resource utilization. Management tasks handled by the Kubernetes infrastructure include controlling resource consumption by an application, automatically load balancing containers among different hosts in the Kubernetes infrastructure, automatically load balancing requests among different instances of an application, migrating applications from one host responsive to processing loads and/or failures of the host, and automatically scaling (adding or deleting application instances) based on load. When combined with a cloud computing platform, Kubernetes provides an attractive option for implementation of many network functions in a communication network, allowing rapid deployment and scaling of the network functions to meet customer demand. Kubernetes has become the standard for running containerized applications in the cloud among providers such as Amazon Web Services (AWS), Microsoft Azure, Google Compute Engine (GCE), IBM and Oracle), which now offer managed Kubernetes services.

Like other distributed computing models, Kubernetes organizes compute and storage resources into clusters. A Kubernetes cluster comprises at least one master node and multiple compute nodes, also known as worker nodes. The master is responsible for exposing the Application Programming Interface (API), deployment of containers and managing the resources of the cluster. Worker nodes are the workhouse of the cluster and handle most processing tasks associated with an application. Worker nodes can be virtual machines (VMs) running on a cloud platform or bare metal (BM) servers running in a data center.

Conventionally, Kubernetes clusters are deployed on hosts within an infrastructure controlled by a single infrastructure provider who owns both the master nodes and the worker nodes. The master node is thus constrained to operate with the resources of a single infrastructure provider. This constraint means that each infrastructure provider needs to dimension its infrastructure to handle all foreseeable workloads. As a consequence, the infrastructure is likely to be over-dimensioned for the majority of applications resulting in a waste of resources and increased cost for the infrastructure provider.

### SUMMARY

The present disclosure provides a system for coordinating the distribution of resource instances (e.g., worker nodes) that belong to different infrastructure providers providing resource instances at different locations. Each infrastructure provider provides one or more resource instances. The resource instances provided by an infrastructure provider can be spread over multiple locations. Several Kubernetes master nodes are deployed to manage the RIs spread among multiple infrastructure providers and multiple locations.

A first aspect of the disclosure comprises methods implemented by a resource coordinator in a cloud platform of coordinating distribution of resource instances belonging to different infrastructure providers. In one embodiment, the method comprises determining a pool of resource instances belonging to two or more different infrastructure providers registered with the cloud platform. The method further comprises distributing the resource instances in the pool among two or more master nodes controlled by the cloud platform to define two or more clusters. Each cluster includes a respective one of the master nodes and at least one resource instance from the pool supervised by the master node for the cluster, and at least one cluster comprises two or more resources instances from the pool belonging to different infrastructure providers.

A second aspect of the disclosure comprises methods implemented by a master node in a distributed computing system for managing a cluster of resource instances selected from a resource pool spanning multiple infrastructure providers. In one embodiment, the method comprises creating a plurality of pods for running application containers and distributing the plurality of pods among a cluster of resource instances selected from a resource pool comprising a plurality of resource instances spanning multiple infrastructure providers, where the cluster comprises resource instances belonging to different infrastructure providers.

A third aspect of the disclosure comprises methods implemented by a service monitor in a cloud platform of monitoring resource instances belonging to different infrastructure providers. In one embodiment, the method comprises collecting data indicative of the performance status of resource instances in a resource pool. The resource pool comprises resource instances belonging to two or more different infrastructure providers registered with the cloud platform. The method further comprises receiving, from a resource coordinator in the cloud platform, a subscription request for status notifications indicative of the performance status of the resource instances in the resource pool. The method further comprises detecting a change in the performance status of one or more of the resource instances in the resource pool, and sending, to the resource coordinator, a status notification, responsive to the change in the performance status.

A fourth aspect of the disclosure comprises methods implemented by an inventory manager in a cloud platform comprising resource instances belonging to different infrastructure providers. In one embodiment, the method comprises maintaining a register of resources instances in a resource pool available to the cloud platform. The resource pool comprises resource instances belonging to two or more different infrastructure providers registered with the cloud platform. The method further comprises receiving, from a resource coordinator in the cloud platform, a subscription request for change notifications indicative of a change in composition of the resource pool. The method further comprises detecting a change in the composition of the resource pool, and sending, to the resource coordinator, a change notification responsive to the change in the composition of the resource pool. The change notification includes a change indicator indicating a change type.

A fifth aspect of the disclosure comprises a resource coordinator in a cloud platform of coordinating distribution of resource instances belonging to different infrastructure providers. In one embodiment, the resource coordinator comprises a determining unit and a distributing unit. The determining unit is configured to determine a pool of resource instances belonging to two or more different infrastructure providers registered with the cloud platform. The distributing unit is configured to distribute the resource instances in the pool among two or more master nodes controlled by the cloud platform to define two or more clusters. Each cluster includes a respective one of the master nodes and at least one resource instance from the pool supervised by the master node for the cluster, and at least one cluster comprises two or more resources instances from the pool belonging to different infrastructure providers.

A sixth aspect of the disclosure comprises a master node in a distributed computing system for managing a cluster of resource instances selected from a resource pool spanning multiple infrastructure providers. In one embodiment, the master node comprises a creating unit and a distributing unit. The creating unit is configured to create a plurality of pods for running application containers. The distributing unit is configured to distribute the plurality pods among a cluster of resource instances selected from a resource pool comprising a plurality of resource instances spanning multiple infrastructure providers, where the cluster comprises resource instances belonging to two different infrastructure providers.

A seventh aspect of the disclosure comprises a service monitor in a cloud platform of monitoring resource instances belonging to different infrastructure providers. In one embodiment, the service monitor comprises a collecting unit, a receiving unit, a detecting unit and a sending unit. The collecting unit is configured to collect data indicative of performance status of resource instances in a resource pool, the resource pool comprising resource instances belonging to two or more different infrastructure providers registered with the cloud platform. The receiving unit is configured to receive, from a resource coordinator in the cloud platform, a subscription request for status notifications indicative of the performance status of the resource instances in the resource pool. The detecting unit is configured to detect a change in the performance status of one or more of the resource instances in the resource pool. The sending unit is configured to send, to the resource coordinator, a status notification, responsive to the change in the performance status.

An eighth aspect of the disclosure comprises an inventory manager in a cloud platform comprising resource instances belonging to different infrastructure providers. In one embodiment, the inventory manager comprises a registration unit, a receiving unit, a detecting unit and a sending unit. The registration unit is configured to maintain a register of resources instances in a resource pool available to the cloud platform. The resource pool comprises resource instances belonging to two or more different infrastructure providers registered with the cloud platform. The receiving unit is configured to receive, from a resource coordinator in the cloud platform, a subscription request for change notifications indicative of a change in composition of the resource pool. The detecting unit is configured to detect a change in the composition of the resource pool. The sending unit is configured to send, to the resource coordinator, a change notification responsive to the change in the composition of the resource pool. The change notification includes a change indicator indicating a change type.

A ninth aspect of the disclosure comprises a resource coordinator in a cloud platform of coordinating distribution of resource instances belonging to different infrastructure providers. In one embodiment, the resource coordinator comprises communication circuitry for communicating over a communication network with master nodes managing resource instances spread among multiple infrastructure providers and processing circuitry. The processing circuitry is configured to determine a pool of resource instances belonging to two or more different infrastructure providers registered with the cloud platform. The processing circuitry is further configured to distribute the resource instances in the pool among two or more master nodes controlled by the cloud platform to define two or more clusters. Each cluster includes a respective one of the master nodes and at least one resource instance from the pool supervised by the master node for the cluster, and at least one cluster comprises two or more resources instances from the pool belonging to different infrastructure providers.

A tenth aspect of the disclosure comprises a master node in a distributed computing system for managing a cluster of resource instances selected from a resource pool spanning multiple infrastructure providers. In one embodiment, the resource coordinator comprises communication circuitry for communicating with a resource coordinator over a communication network. The processing circuitry is configured to create a plurality of pods for running application containers and distributing the plurality of pods among a cluster of resource instances selected from a resource pool comprising a plurality of resource instances spanning multiple infrastructure providers. The cluster comprises resource instances belonging to two different infrastructure providers.

An eleventh aspect of the disclosure comprises a service monitor in a cloud platform of monitoring resource instances belonging to different infrastructure providers. In one embodiment, the service comprises communication circuitry for communicating with a resource coordinator over a communication network. The processing unit is configured to collect data indicative of performance status of resource instances in a resource pool, the resource pool comprising resource instances belonging to two or more different infrastructure providers registered with the cloud platform. The processing unit is configured to receive, from a resource coordinator in the cloud platform, a subscription request for status notifications indicative of the performance status of the resource instances in the resource pool. The processing unit is further configured to detect a change in the performance status of one or more of the resource instances in the resource pool and send, to the resource coordinator, a status notification, responsive to the change in the performance status.

A twelfth aspect of the disclosure comprises an inventory manager in a cloud platform comprising resource instances belonging to different infrastructure providers. In one embodiment, the inventory manager comprises communication circuitry for communicating with a resource coordinator over a communication network. The processing unit is configured to maintain a register of resources instances in a resource pool available to the cloud platform. The resource pool comprises resource instances belonging to two or more different infrastructure providers registered with the cloud platform. The processing unit is further configured to receive, from a resource coordinator in the cloud platform, a subscription request for change notifications indicative of a change in composition of the resource pool. The processing unit is further configured to detect a change in the composition of the resource pool and send, to the resource coordinator, a change notification responsive to the change in the composition of the resource pool. The change notification includes a change indicator indicating a change type.

A thirteenth aspect of the disclosure comprises a computer program for a resource controller in a cloud platform system. The computer program comprises executable instructions that, when executed by processing circuitry in the resource controller, causes the resource controller to perform the method according to the first aspect.

A fourteenth aspect of the disclosure comprises a carrier containing a computer program according to the thirteenth aspect. The carrier is one of an electronic signal, optical signal, radio signal, or a non-transitory computer readable storage medium.

A fifteenth aspect of the disclosure comprises a computer program for a master node in a distributed computing system (e.g., Kubernetes). The computer program comprises executable instructions that, when executed by processing circuitry in the master node, causes the master to perform the method according to the first aspect.

A sixteenth aspect of the disclosure comprises a carrier containing a computer program according to the fifteenth aspect. The carrier is one of an electronic signal, optical signal, radio signal, or a non-transitory computer readable storage medium.

A seventeenth aspect of the disclosure comprises a computer program for a service monitor in a cloud platform. The computer program comprises executable instructions that, when executed by processing circuitry in the service monitor, causes the master to perform the method according to the first aspect.

An eighteenth aspect of the disclosure comprises a carrier containing a computer program according to the seventeenth aspect. The carrier is one of an electronic signal, optical signal, radio signal, or a non-transitory computer readable storage medium.

A nineteenth aspect of the disclosure comprises a computer program for an inventory manager in a cloud platform. The computer program comprises executable instructions that, when executed by processing circuitry in the master node, causes the master to perform the method according to the first aspect.

A twentieth aspect of the disclosure comprises a carrier containing a computer program according to the ninetieth aspect. The carrier is one of an electronic signal, optical signal, radio signal, or a non-transitory computer readable storage medium.

### BRIEF DESCRIPTION OF THE DRAWINGS

FIG. 1 illustrates an Open Edge Cloud Platform (OECP) for providing Infrastructure as a Service (IaaS) and/or Platform as a Service (PaaS).

FIG. 2 illustrates a Kubernetes cluster.

FIG. 3 illustrates the main functional components in a master node and worker node of a Kubernetes cluster.

FIG. 4 illustrates a typical deployment of a cluster across multiple hosts in a production environment.

FIG. 5 illustrates a Kubernetes cluster having resources instances spread over multiple infrastructure providers.

FIG. 6 illustrates OECP components for managing and orchestration resource instances provided by a Kubernetes platform.

FIG. 7 illustrates the transition of resource instances within the same infrastructure provider from one Kubernetes master to another.

FIG. 8 illustrates an exemplary signaling flow for incorporating a new worker node into an existing Kubernetes platform.

FIG. 9 is a signaling flow for incorporating a new worker node 70 into an existing Kubernetes platform.

FIG. 10 is a signaling flow for switching a resource instance from one Kubernetes mast to another.

FIG. 11 is a method implemented by a resource coordinator in a cloud platform of coordinating distribution of resource instances belonging to different infrastructure providers.

FIG. 12 is a method implemented by a master node in a distributed computing system of managing a cluster of resource instances selected from a resource pool spanning multiple infrastructure providers.

FIG. 13 is a method implemented by a service monitor in a cloud platform comprising resources instances spread over multiple infrastructure providers.

FIG. 14 is a method implemented by an inventory manager in a cloud platform comprising resources instances spread over multiple infrastructure providers.

FIG. 15 is a resource coordinator in a cloud platform configured to coordinate distribution of resource instances belonging to different infrastructure providers.

FIG. 16 is a master node in a distributed computing system configured to manage a cluster of resource instances selected from a resource pool spanning multiple infrastructure providers.

FIG. 17 is a service monitor in a cloud platform comprising resources instances spread over multiple infrastructure providers.

FIG. 18 is an inventory manager in a cloud platform comprising resources instances spread over multiple infrastructure providers.

FIG. 19 illustrates the main functional components of a network device that can be configured as a resource coordinator, service monitor or inventory manager in a cloud platform, or as a master node in a distributed computing system.

### DETAILED DESCRIPTION

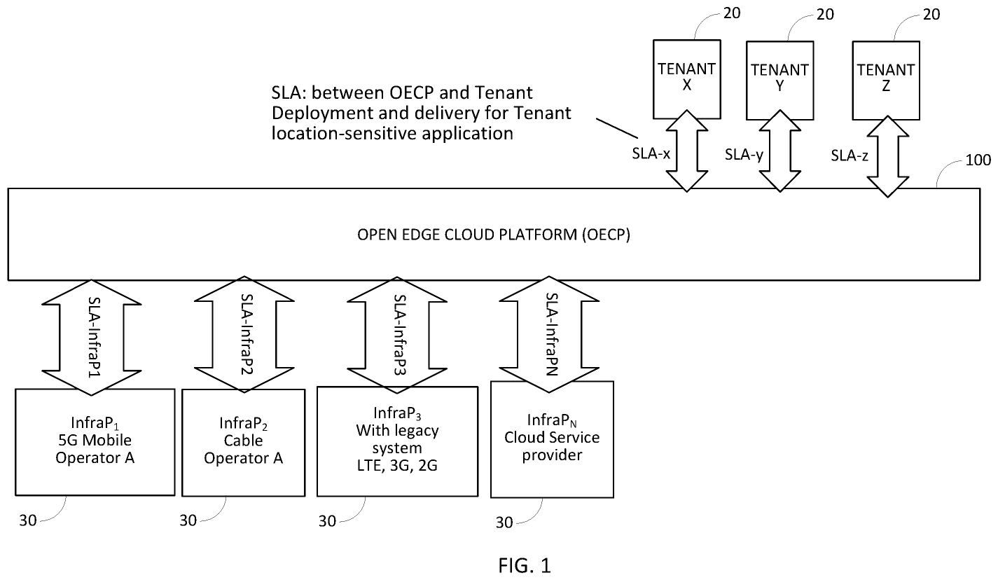

Referring now to the drawings, FIG. 1 illustrates an open edge cloud platform (OECP) 100 for providing infrastructure as a service (IaaS). The OECP 100 extends the traditional business relationship between service providers, i.e. infrastructure providers 30, and service consumers, i.e., tenants 20. The OECP 100 is built on top of the infrastructure owned by different infrastructure providers 30, but the operation of the OECP 100 is carried out by a platform owner, which may be a third party. The infrastructure providers 30 join the OECP 100 and make edge resources available to tenants 20 via the OECP 100. Service-level agreements (SLAs) between the OECP operator and infrastructure providers 30 define the services and resources that are made available to the OECP 100 by the infrastructure providers 30, such as computing power, storage, plus the features required for the network connectivity. The OECP 100 provides virtual networking and infrastructure services, such as Software Defined Networks (SDNs), Virtual Network Functions (VNFs), Virtual Machine as a Service (VMaaS) and Bare Metal as a service (BMaaS), to tenants 20 for location-sensitive applications and is publicly accessible to any tenant 20 who is interested in deploying its application in the cloud. From the tenant's perspective, the tenant 20 deals with a single cloud service provider, i.e., the OECP operator, instead of multiple service providers (e.g., infrastructure providers 30). The OECP operator enters into SLAs with tenants 20 that define the deployment and delivery requirements for the tenant's applications. An exemplary open edge cloud platform is described in PCT Application PCT/IB2020/053825 filed 22 Apr. 2020.

One aspect of the present disclosure comprises an architecture for orchestrating deployment of Kubernetes containers in an OECP 100 where the hosts for the Kubernetes containers are spread across infrastructure providers provided by different infrastructure providers 30. In large scale productions, such as communication networks, workloads can have a large number of application containers spread across multiple hosts provided by different infrastructure providers 30.

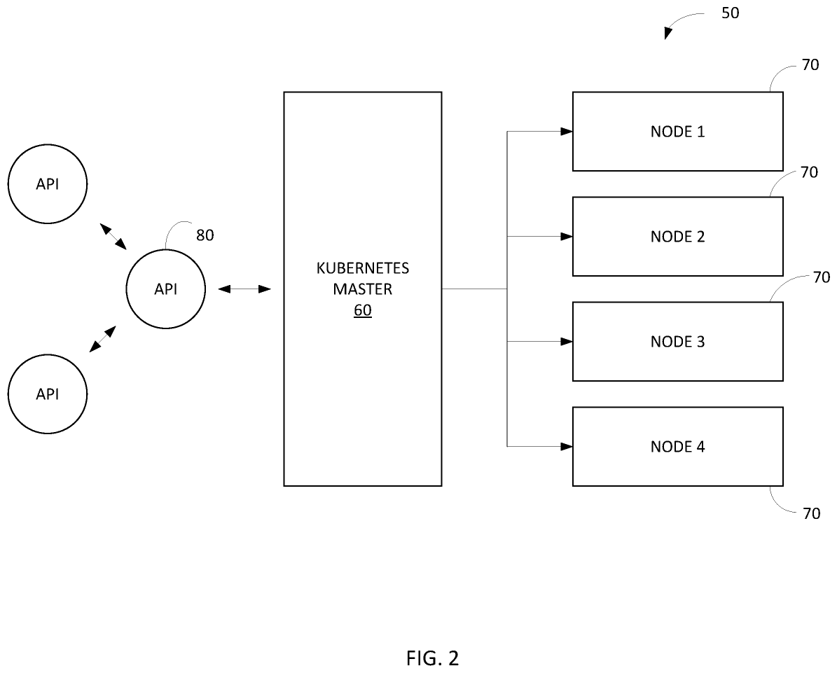

FIG. 2 is an overview of a typical Kubernetes architecture. Like other distributed computing models, compute and storage resources are organized into clusters 50. A Kubernetes cluster 50 comprises at least one master node 60 and multiple compute nodes, also known as worker nodes 70. The master node 60 is responsible for exposing the Application Programming Interface (API) 80, deployment of containers and managing the resources of the cluster 50. Worker nodes 70 are the workhouse of the cluster 50 and handle most processing tasks associated with an application. Worker nodes 70 can be virtual machines (VMs) running on a cloud platform or bare metal (BM) servers running in a data center.

The basic unit for resources management in Kubernetes cluster 50 is a pod. A pod comprises a collection of one or more containers that share the same host resources. Each pod is assigned an IP address on which it can be accessed by other pods within a cluster 50. Data generated by containers within a pod can be stored in a volume, which persists when a pod is deleted. Applications within a pod have access to shared volumes, which provides persistent storage for data generated or used by an application container in the pod. The grouping mechanism of pods makes it possible to run multiple dependent processes together. At runtime, pods can be scaled by creating replica sets, which ensure that an application always has a sufficient number of pods.

A single pod or replica set is exposed to service consumers via a service. Services enable the discovery of pods by associating a set of pods to a specific function. Key-value pairs called labels and selectors enable the discovery of pods by service consumers. Any new pod with labels that match the selector will automatically be discovered by the service.

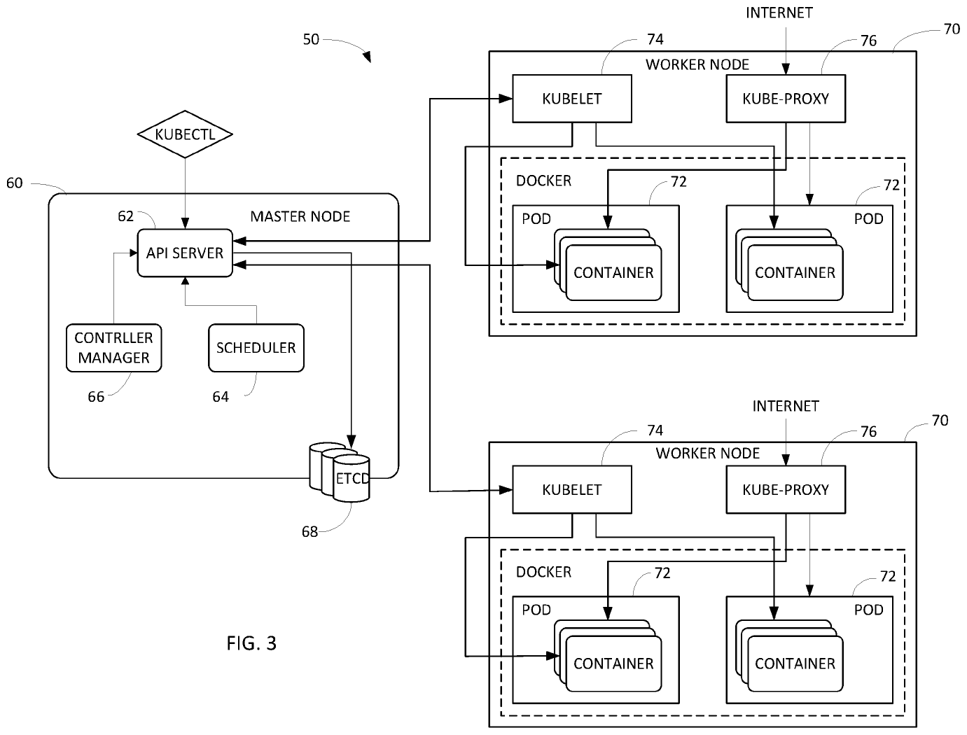

Referring to FIG. 3, the main components of the Kubernetes master node 60 comprise an API server 62, scheduler 64, controller manager 66 and a data store called etcd 68. The API server 62 is a control plane component that exposes the Kubernetes API and serves as the front end of the Kubernetes cluster 50. The scheduler 64 is a control plane component that watches for newly created pods and assigns the pod to a worker node 70 based on factors such as individual and collective resource requirements, hardware constraints, operator policy, etc. The controller manager 66 is a control plane component comprising a collection of controller processes that together handle most of the control functions for the Kubernetes cluster 50. A node controller within the controller manager monitors the nodes within the cluster 50 and initiates failure recovery procedures when a node fails or goes down. A replication controller within the controller manager ensures that a specified number of pod replicas are running at any one time. The etcd 68 is a highly available data store for backing up all cluster 50 data, such as key-value pairs.

Each worker node 70 runs a container runtime 72, such as Docker or rkt, along with an agent called a kubelet 74 that communicates with the master node 60. The container runtime 72 is a software component that runs containers. The kubelet 74 receives pod specifications from the master node 60 and makes sure that containers described in the pod specifications are running. The worker node 70 may also include a network proxy 76 called the kube-proxy, that enables communication with the pods over a communication network.

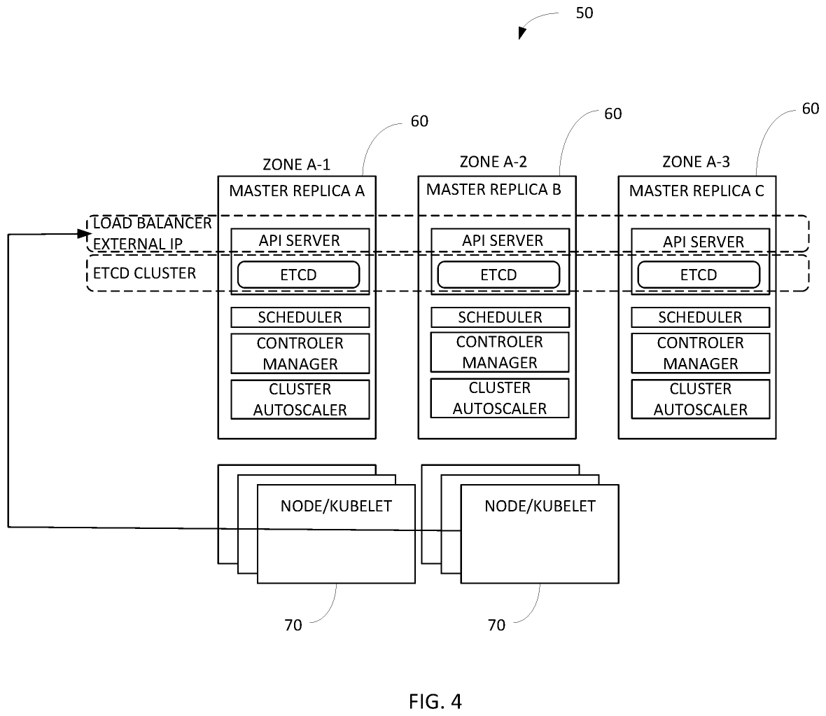

In production environments, the control plane usually runs across multiple hosts and a cluster 50 usually has multiple worker nodes 70 as shown in FIG. 4. Multiple master nodes 60 in each cluster 50, typically an odd number with a minimum of three master nodes 60, ensure high availability and fault tolerance for the cluster 50. Conventionally, Kubernetes clusters 50 are deployed on hosts within an infrastructure provided by a single infrastructure provider who owns both the master nodes 60 and the worker nodes 70. The master node 60 is thus constrained to operate with the resources of a single infrastructure provider. This constraint means that each infrastructure provider needs to dimension its infrastructure to handle all foreseeable workloads. As a consequence, the infrastructure is likely to be over-dimensioned for the majority of applications resulting in a waste of resources and increased cost for the infrastructure provider.

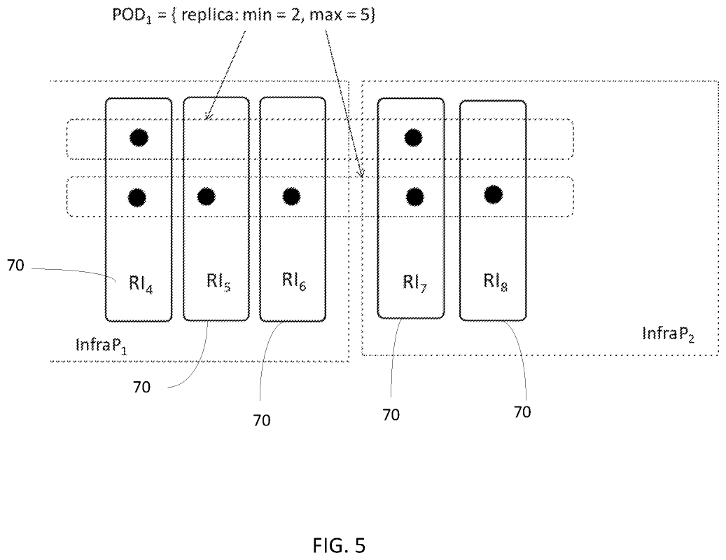

The orchestration system as herein described enables Kubernetes clusters 50 having worker nodes 70 that are spread across hosts residing within two or more different infrastructure providers giving the master nodes 60 access to a potentially larger collection of resources. The orchestration system allows resources in different infrastructure providers to be dynamically allocated and shared according to the traffic patterns on the data plane. For example, FIG. 5 illustrates a Kubernetes cluster 50 having access to resources in two different infrastructure providers, which can be provided by the same provider or different providers. Infrastructure 1 (InfraP₁) includes three resource instances (RIs) or host for running application containers, while Infrastructure 2 (InfraP₂) includes 2 hosts. The RIs serve as the hosts for the worker nodes 70 in Kubernetes cluster. The Kubernetes cluster 50 deploys a replica set denoted as Pod₁ containing a minimum of 2 pods and a maximum of 5 pods. At time t₀, the Kubernetes cluster 50 deploys two pods, illustrated as solid circles inside the RIs), one in RI1 and one in RI4. The pods in this case are deployed in two infrastructure providers, providing increased robustness against host failure. As the workload increases, more pods can be deployed to meet the increased demand. At time t₁, the Kubernetes cluster 50 has deployed five pods spread across five different resource RIs spread across two different infrastructure providers.

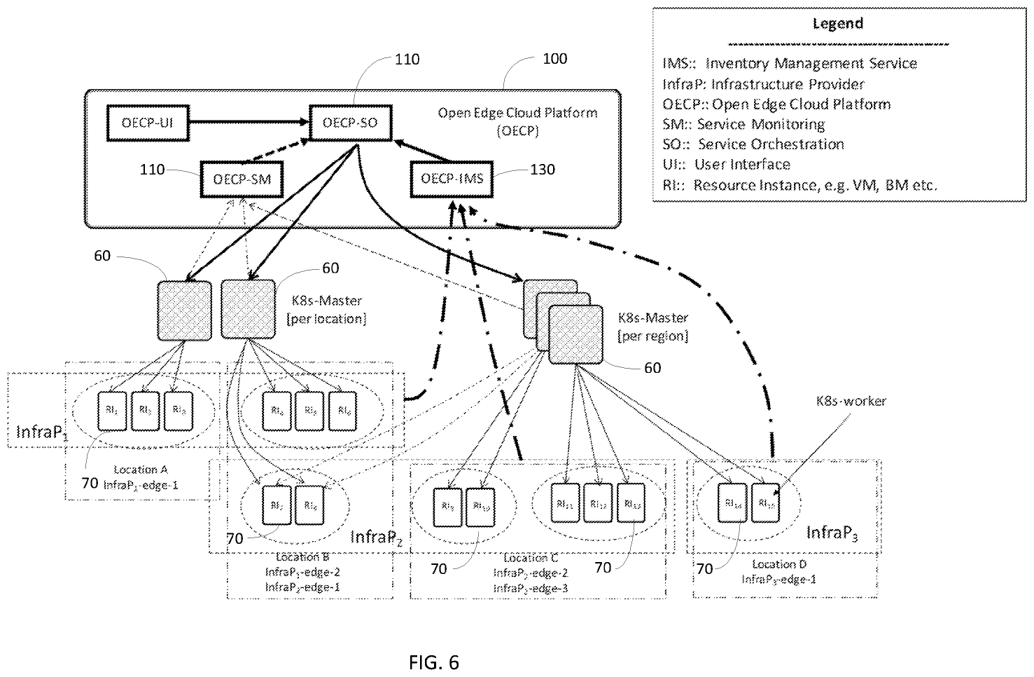

To enable coordination of RIs that belong to two different infrastructure providers, the OECP 100 provides a management and orchestration components on top of the Kubernetes platform as shown in FIG. 6. The Kubernetes master nodes 60 are placed under the control of the OECP 100. The management and orchestration components provide the master nodes 60 access to RIs in two or more different infrastructure providers so that the master nodes 60 in a Kubernetes cluster 50 can dynamically allocate pods to RIs in two or more different infrastructure providers. Generally, one or more master nodes 60 are designed for each location or region and the master nodes 60 have access to all resources offered by the OECP 100 in their respective locations or regions. In the example shown in FIG. 6, there are three infrastructure providers, denoted as InfraP₁, InfraP₂ and InfraP₃ respectively, that own RIs in four locations, denoted Location A, Location B, Location C and Location D respectively. InfraP1 has 6 RIs spread over Location A (3 RIs) and Location B (3 RIs). InfraP2 has 7 RIs spread over Location B (2 RIs) and Location C (5 RIs). InfraP3 has 2 RIs at Location D. Locations B, C a D are within the same region. Master node K8-M1 has access to RIs in Location A. Master node K8-M2 has access to RIs at Location B. Master node K8-M3 has access to RIs in Locations B, C and D.

OECP 100 serves as the central backend office to manage the Kubernetes master nodes 60. The main components of the OECP 100 comprise the OECP service orchestrator (OECP-SO) 110, the OECP service monitor (OECP-SM) 120 and the OECP inventory manager (OECP-IM) 130. The OECP-SO 110 analyzes the traffic and makes decisions about the distribution of the RIs across different infrastructure providers based on predetermined criteria, such as the overall capacity of the Kubernetes cluster 50 in terms of the throughput or CPU usage. The OECP-SM 120 collects data about the traffic pattern and workload on the RIs in different infrastructure providers through Kubernetes master nodes 60 and sends notifications or alert to the OECP-SO 110 based on the criteria for the distribution of the worker nodes 70 through its monitoring service. The OECP-IM 130 collects information about the inventory of resource and sends notifications to the OECP-SO 110 when any resource instance is added or removed by infrastructure. With these three components, OECP 100 can assign RIs within different infrastructure providers to the same Kubernetes master node 60 and transfer RIs in any infrastructure to any Kubernetes master node 60.

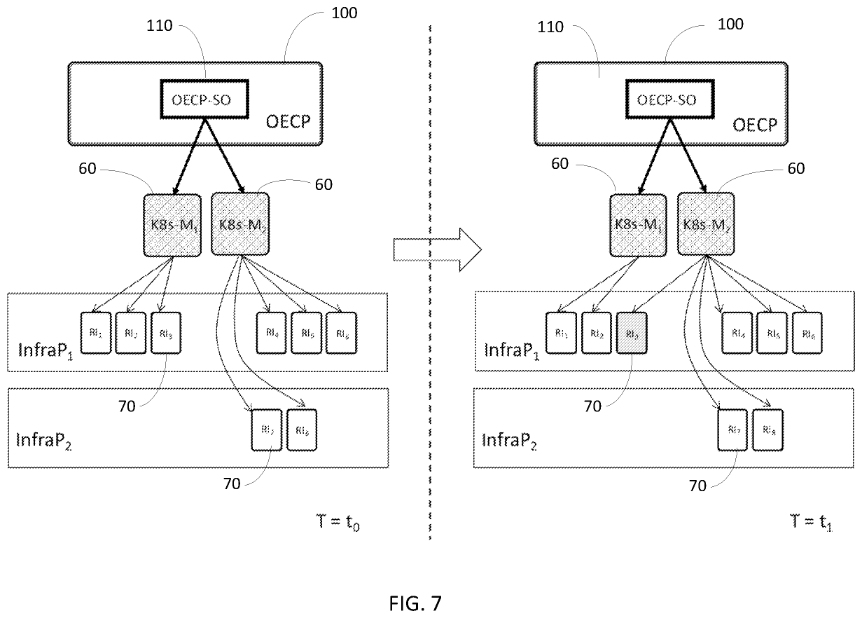

FIG. 7 illustrates the transition of RIs within the same infrastructure from one Kubernetes master (K8 master) to another. On the left side in FIG. 7, two K8 masters, denoted K8-M1 and K8-M2, are deployed to manage the RIs of different infrastructure providers, which are deployed at different locations. Based on feedback from OECP-SM 120, the number of pods managed by K8s-M2 experiences a sudden increase in the number of client requests and needs more RIs to accommodate the sudden increase in traffic. Based on the information received from OECP-SM 120 regarding the traffic and resource utilization, the OECP-SO 110 decides to remove RI3 from the cluster 50 managed by K8s-M1 and add it to the cluster 50 managed by K8s-M2. To achieve this, OECP-SO 110 sends a request/instruction to the corresponding K8 master. For remove/deletion operation on the worker node 70, the OECP-SO 110 shall make a sure that the K8 master will perform a graceful shutdown instead of a hard remove or deletion in order to avoid any impact on the services provided to OECP tenants or end users, such as application subscribers.

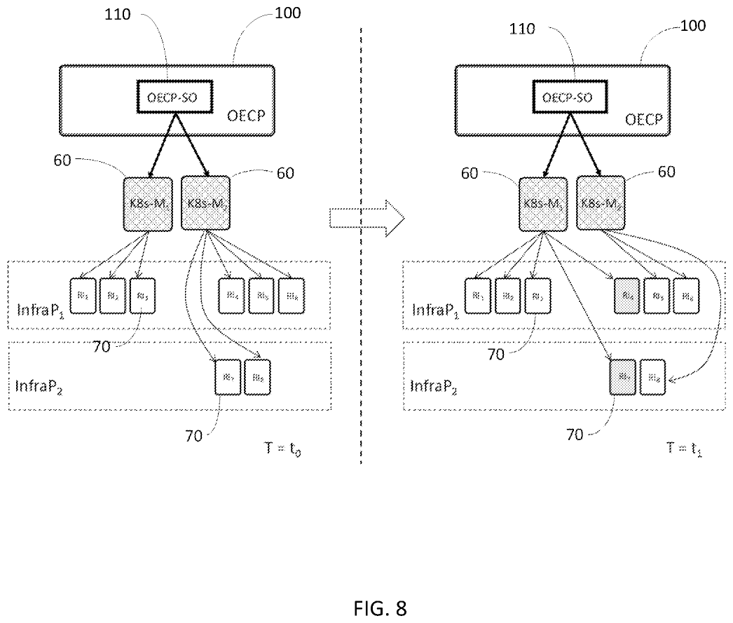

FIG. 8 illustrates the transition of RIs within different infrastructure providers from one K8 master to another. In this example, the worker nodes 70 in the cluster 50 managed by K8s-M1 is receiving more traffic than is expected. Based on information provided by OECP-SM 120, OECP-SO 110 decides to move two RIs under K8s-M2 into a cluster 50 of worker nodes 70 managed by K8s-M1. Among those two RIs, one is taken from InfraP1 and the other is taken from InfraP2.

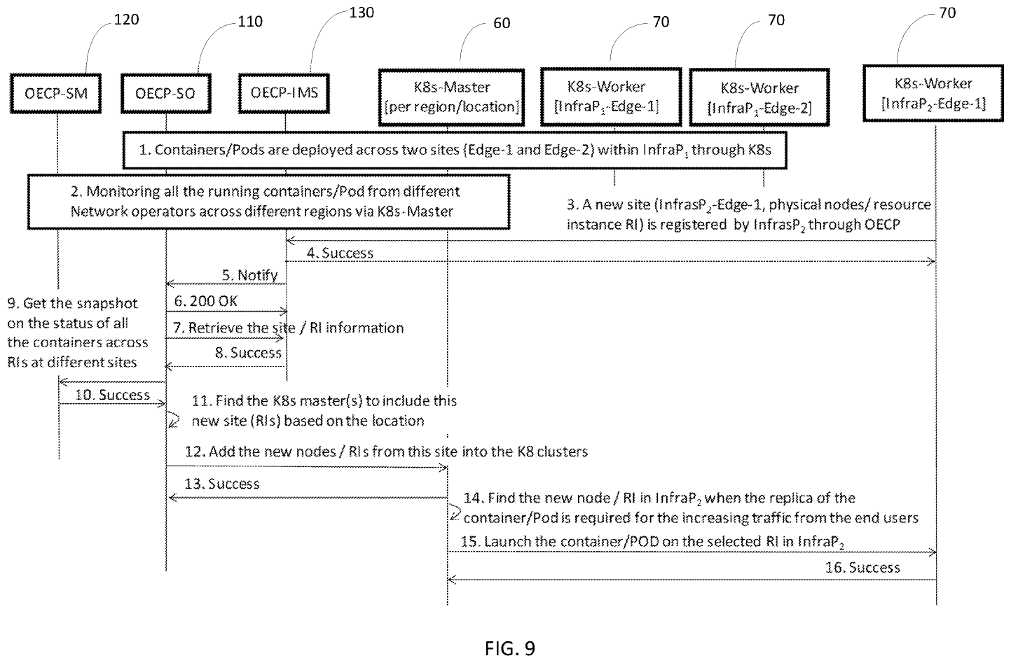

FIG. 9 illustrates an exemplary signaling flow for incorporating a new worker node 70 into an existing Kubernetes platform. After a new RI is installed/deployed in the site of InfraP2, it is registered with OECP 100 through OECP-IM 130. The registration triggers OECP-SO 110 to locate the best K8 master to manage this new RI. The following process is one of many examples for adding the new resource instance.

1. The Kubernetes environment is successfully built for all RIs deployed within two sites of the same infrastructure provider, i.e. InfraP1.

2. OECP-SM 120 monitors all the worker nodes 70 through the K8-master nodes 60.

3. InfraP2 installs the new instance (RI) in its network and registers the corresponding information with OECP-IM 130.

4. OECP-IM 130 accepts the registration and stores the information in the registration database successfully.

5. OECP-IM 130 notifies OECP-SO 110 about the changes in the managed hardware.

6. OECP-SO 110 confirms that it has received the notification.

7. OECP-SO 110 retrieves the detailed information about the changes from OECP-IM 130S. The information includes a description of the new instance.

8. OECP-IM 130 returns the requested information to OECP-SO 110.

9. OECP-SO 110 sends a query about the working status of all worker nodes 70, such as CPU usage, availability, storage usage, as well as the network capacity.

10. OECP-SM 120 returns the requested information to OECP-SO 110.

11. Based on all the collected information, especially location, OECP-SO 110 selects a K8-master, which shall manage the new worker node 70.

12. OECP-SO 110 sends the instruction to the selected K8-master to add this new node into its cluster 50 of worker node 70.

13. K8-master accepts the request from OECP-SO 110 and sends the confirmation back.

14. K8s-master finds the new worker node 70.

15. On the new instance, K8s-master launches the container/Pods that have been deployed in the previous cluster 50 of worker nodes 70.

16. The new instance returns “Success” after it performs the instruction from K8s-master successfully.

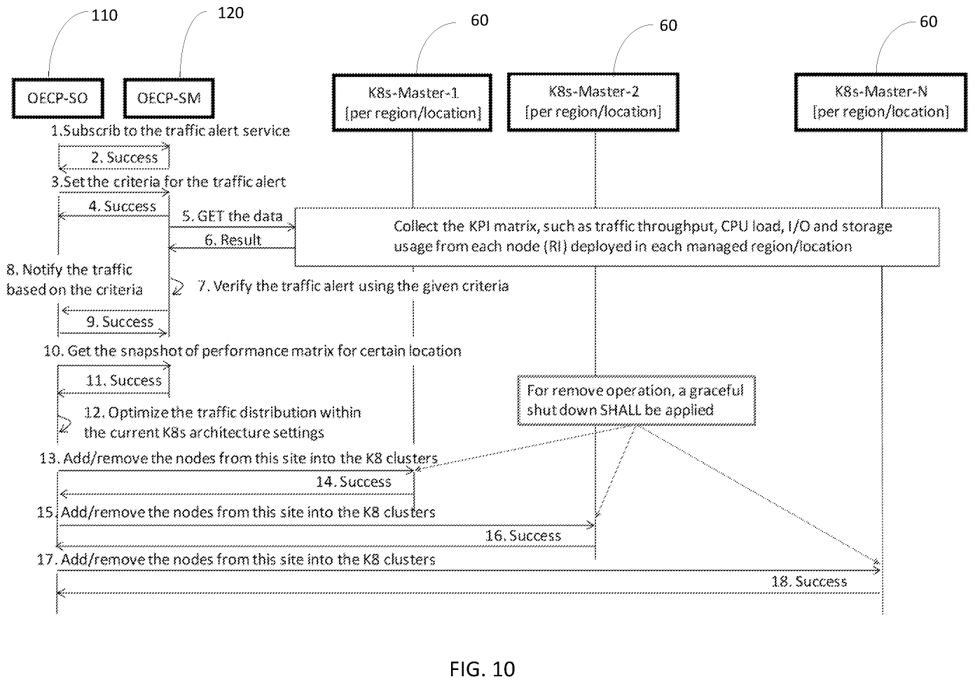

FIG. 10 illustrates an exemplary signaling flow for switching a resource instance from one Kubernetes master to another. When the traffics towards a pod changes, the change in traffic triggers OECP 100 to move a RI from one K8s-master to the other. The following process is one of examples for moving a resource instance between K8 masters.

1. OECP-SO 110 subscribes to the monitoring service offered by OECP-SM 120.

2. OECP-SM 120 sends a confirmation.

3. OECP-SO 110 provides a criteria or policy for OECP-SM 120 to generate an alert or notification.

4. OECP-SM 120 returns a confirmation.

5. OECP-SM 120 collects the data from all the K8-masters about the status for those managed worker nodes 70.

6. K8-masters return the requested data to OECP-SM 120.

7. Based on the given criteria, OECP-SM 120 generates an alert.

8. OECP-SM 120 sends the alert to OECP-SO 110.

9. OECP-SO 110 returns the confirmation after receiving the alert.

10. OECP-SO 110 retrieves the snapshot of all the worker nodes 70 for the given location from OECP-SM 120.

11. OECP-SM 120 returns the requested data.

12. OECP-SO 110 optimizes the distribution of the worker nodes 70 based on the collected traffic-related information.

13. OECP-SO 110 sends the instruction to the corresponding K8-master in order to add or remove the worker nodes 70 at certain location, e.g. K8-M1

14. After the instruction is successfully executed by K8-M1, the success confirmation is returned to OECP.

15. OECP-SO 110 sends the instruction to the corresponding K8-M2 in order to add or remove the worker nodes 70 at certain location, e.g. K8-M2

16. After the instruction is successfully executed by K8-M2, the success confirmation is returned to OECP.

17. OECP-SO 110 sends the instruction to the corresponding K8s-master in order to add or remove the worker nodes 70 at certain location, e.g. K8-M3

18. After the instruction is successfully executed by K8-M3, the success confirmation is returned to OECP.

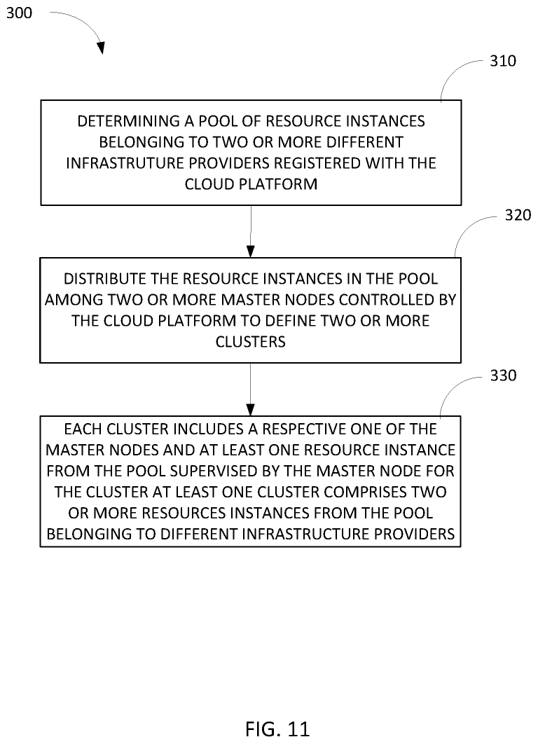

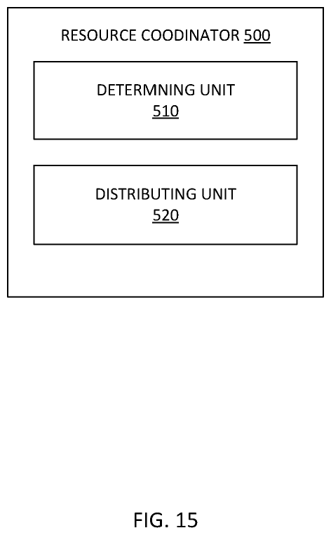

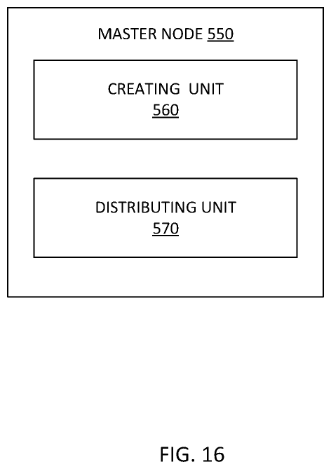

FIG. 11 is a method 300 implemented by a resource coordinator 500 (shown in FIG. 15) in a cloud platform of coordinating distribution of RIs belonging to different infrastructure providers. The resource coordinator 500 may, for example, comprise an OECP-SO 110 as described above. In one embodiment, the method 100 comprises determining a pool of RIs belonging to two or more different infrastructure providers registered with the cloud platform (block 310). The method further comprises distributing the RIs in the pool among two or more master nodes 550 (FIG. 16) controlled by the cloud platform to define two or more clusters (block 320). Each cluster including a respective one of the master nodes 550 and at least one resource instance from the pool supervised by the master node 550 for the cluster, and at least one cluster comprises two or more resources instances from the pool belonging to different infrastructure providers (block 330).

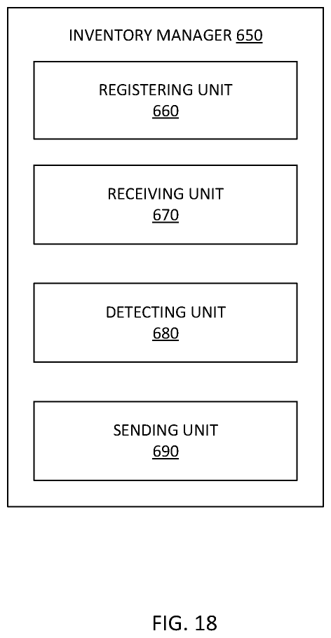

In some embodiments of the method 300, determining a pool of RIs belonging to two or more different infrastructure providers registered with the cloud platform comprises receiving inventory information from an inventory manager 650 (FIG. 18), the inventory information indicating the RIs belonging to two or more different infrastructure providers and locations of the RIs. In some embodiments, the inventory information is received responsive to an information request from the coordinating entity.

In some embodiments of the method 300, determining available RIs belonging to two or more different infrastructure providers comprises subscribing with an inventory manager 650 to receive notifications related to an inventory of RIs, and receiving, according to the subscription, notifications from the inventory manager, the notifications including inventory information

In some embodiments of the method 300, distributing the resources instances in the pool is based at least in part on the locations of the RIs. Distributing the resources instances in the pool can be further based on available capacities of the RIs, capabilities of the RIs, or both.

In some embodiments of the method 300, distributing RIs from the pool further comprises, for each of one or more RIs, reassigning the resource instance from a current cluster to which the resource instance is currently assigned to a target cluster to which the resource instance is reassigned.

In some embodiments of the method 300, two or more RIs belonging to the same infrastructure and in the same current cluster are reassigned to the same target cluster.

In some embodiments of the method 300, two or more RIs belonging to different infrastructure providers and in the same current cluster are reassigned to the same target cluster.

In some embodiments of the method 300, two or more RIs belonging to the same infrastructure and in the same current cluster are reassigned to different target clusters.

In some embodiments of the method 300, two or more RIs belonging to different infrastructure providers and in the same current cluster are reassigned to different target clusters.

Some embodiments of the method 300 further comprise receiving a change notification indicating that a new resource instance has been added to the resource pool, and responsive to the notification, assigning the new resource instance to a selected cluster.

Some embodiments of the method 300 further comprise redistributing one or more RIs in the selected cluster among one or more target clusters responsive to the change notification.

Some embodiments of the method 300 further comprise removing a resource instance from a selected cluster and redistributing one or more RIs selected from one or more other clusters to the selected cluster.

Some embodiments of the method 300 further comprise prior to receiving the change notification, subscribing with an inventory manager 650 to receive notifications related to changes in the resources pool, wherein the change notification is received from the inventory manager 650 according to the subscription.

Some embodiments of the method 300 further comprise receiving a status notification indicating a performance status of one or more RIs in the resource pool and, responsive to the status notification, redistributing one or more RIs in the resource pool.

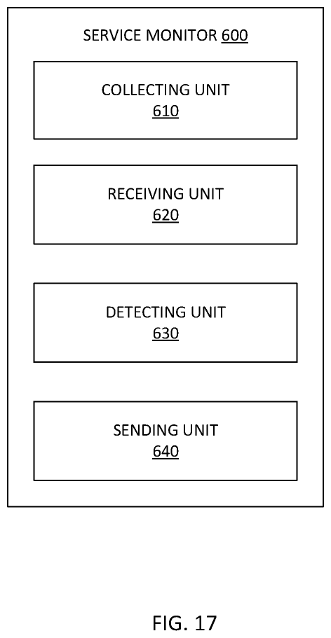

Some embodiments of the method 300 further comprise prior to receiving the status notification, subscribing with a service monitor 600 to receive notifications related to the performance status of resources instances in the resources pool, wherein the status notification is received from the service monitor 600 (FIG. 17) according to the subscription.

In some embodiments of the method 300, redistributing one or more RIs in the resource pool comprises, for each of one or more RIs, reassigning the resource instance from a current cluster to which the resource instance is currently assigned to a target cluster to which the resource instance is reassigned.

In some embodiments of the method 300, two or more RIs belonging to the same infrastructure provider and in the same current cluster are reassigned to the same target cluster.

In some embodiments of the method 300, two or more RIs belonging to different infrastructure providers and in the same current cluster are reassigned to the same target cluster.

In some embodiments of the method 300, two or more RIs belonging to the same infrastructure provider and in the same current cluster are reassigned to different target clusters.

In some embodiments of the method 300, two or more RIs belonging to different infrastructure providers and in the same current cluster are reassigned to different target clusters.

Some embodiments of the method 300 further comprise determining a number of RIs, and dynamically deploying the master nodes 550 based on the number of RIs.

Some embodiments of the method 300 further comprise determining locations of the RIs, and dynamically deploying the master nodes 550 based on the locations of RIs.

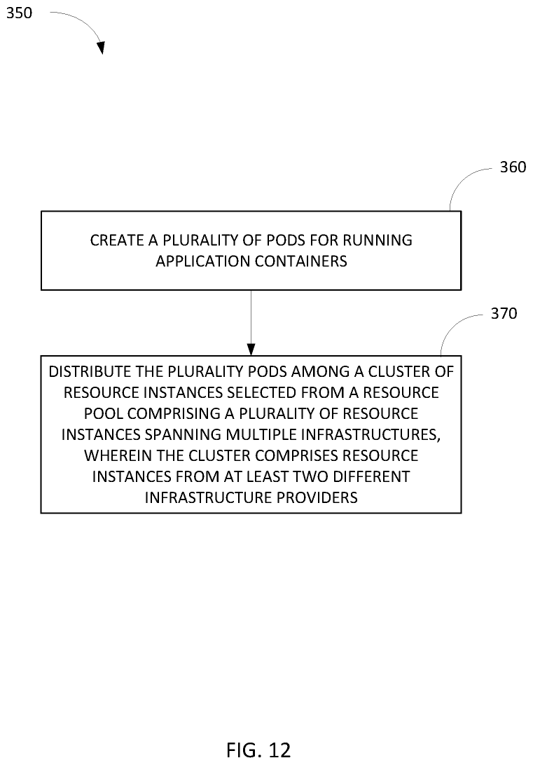

FIG. 12 is a method 350 implemented by a master node 550 (shown in FIG. 16) in a distributed computing system (e.g., Kubernetes) of managing a cluster of RIs selected from a resource pool spanning multiple infrastructure providers. In one embodiment, the method 350 comprises creating a plurality of pods for running application containers (block 360) and distributing the plurality of pods among a cluster of RIs selected from a resource pool comprising a plurality of RIs spanning multiple infrastructure providers, where the cluster comprises RIs belonging to two different infrastructure providers (block 370).

Some embodiments of the method 350 further comprise receiving, from a resource coordinator 500, a configuration message identifying a new resource instance to be added to the cluster and adding, responsive to the control message, the new resource instance to the cluster.

Some embodiments of the method 350 further comprise reassigning one or more pods currently assigned to other RIs to the new resource instance.

Some embodiments of the method 350 further comprise creating a new pod for running application containers and assigning the new pod to one of the RIs in the cluster.

Some embodiments of the method 350 further comprise receiving, from a resource coordinator 500, a configuration message indicating a resource instance to be removed from the cluster and removing, responsive to the control message, the indicated resource instance from the cluster.

Some embodiments of the method 350 further comprise reassigning one or more pods assigned to the resource instance that was removed to one or more remaining RIs.

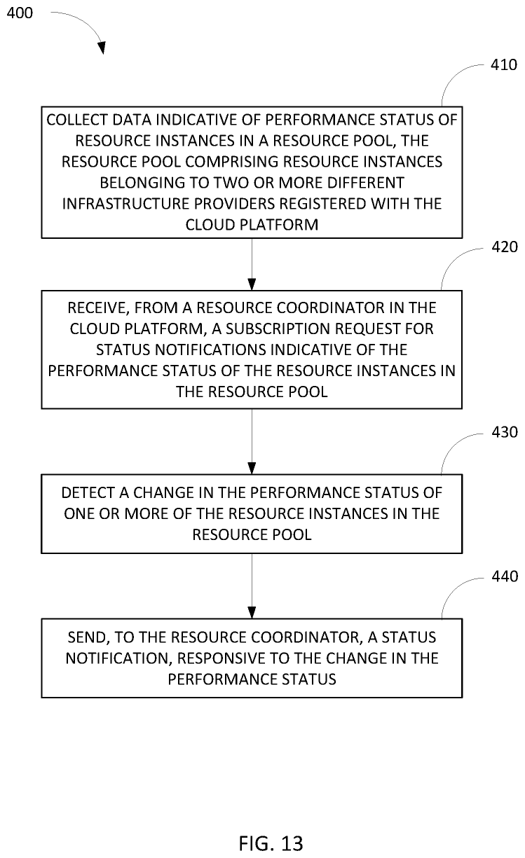

FIG. 13 is a method 400 implemented by a service monitor 600 (shown in FIG. 17) in a cloud platform comprising resources instances spread over multiple infrastructure providers. In one embodiment, the method 400 comprises collecting data indicative of performance status of RIs in a resource pool, the resource pool comprising RIs belonging to two or more different infrastructure providers registered with the cloud platform (block 410). The method further comprises receiving, from a resource coordinator 500 in the cloud platform, a subscription request for change notifications indicative of a change in the performance status of the RIs in the resource pool (block 420). The method further comprises detecting a change in the performance status of one or more of the RIs in the resource pool (block 430), and sending, to the resource coordinator 500, a change notification, responsive to the change in the performance status (block 440).

In some embodiments of the method 400, the subscription request includes an event trigger defining a predetermined criterion for triggering the change notification.

In some embodiments of the method 400, the event trigger comprises a threshold for a predetermined performance metric.

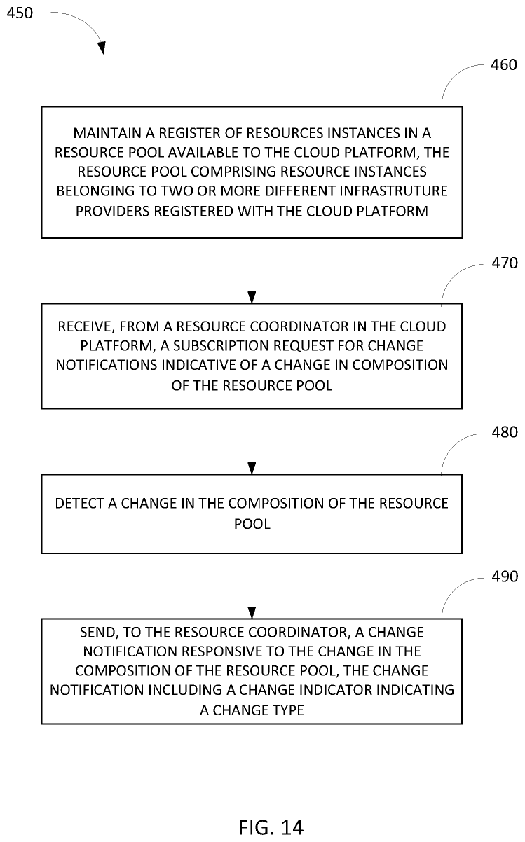

FIG. 14 is a method 450 implemented by an inventory manager 650 (shown in FIG. 18) in a cloud platform comprising resources instances spread over multiple infrastructure providers. In one embodiment, the method 450 comprises maintaining a register of resources instances in a resource pool available to the cloud platform (block 460). The resource pool comprises RIs belonging to two or more different infrastructure providers registered with the cloud platform. The method 450 further comprises receiving, from a resource coordinator 500 in the cloud platform, a subscription request for change notifications indicative of a change in composition of the resource pool (block 470). The method further comprises detecting a change in the composition of the resource pool (block 480), and sending, to the resource coordinator 500, a change notification responsive to the change in the composition of the resource pool (block 490). The change notification includes a change indicator indicating a change type.

In some embodiments of the method 450, the change indicator indicates addition of a new resource instance to the resource pool.

Some embodiments of the method 450 further comprise receiving, from the resource coordinator 500, an information request requesting information for the new resource instance and sending, responsive to the information request, information describing the new resource instance to the resource coordinator 500.

In some embodiments of the method 450, the change indicator indicates removal of a resource instance from the resource pool.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

FIG. 15 is a resource coordinator 500 in a cloud platform configured to coordinate distribution of RIs belonging to different infrastructure providers. In one embodiment, the resource coordinator 500 comprises a determining unit 510 and a distributing unit 520. The determining unit is configured to determine a pool of RIs belonging to two or more different infrastructure providers registered with the cloud platform. The distributing unit is configured to distribute the RIs in the pool among two or more master nodes 550 controlled by the cloud platform to define two or more clusters, where each cluster includes a respective one of the master nodes 550 and at least one resource instance from the pool supervised by the master node 550 for the cluster, and at least one cluster comprises two or more resources instances from the pool belonging to different infrastructure providers.

FIG. 16 is a master node 550 in a cloud platform configured to manage a cluster of RIs selected from a resource pool spanning multiple infrastructure providers. In one embodiment, the master node 550 comprises a creating unit 560 and a distributing unit 570. The creating unit is configured to create a plurality of pods for running application containers. The distributing unit is configured to distribute the plurality pods among a cluster of RIs selected from a resource pool comprising a plurality of RIs spanning multiple infrastructure providers, where the cluster comprises RIs belonging to different infrastructure providers.

FIG. 17 is a service monitor 600 in a cloud platform comprising resources instances spread over multiple infrastructure providers. In one embodiment, the service monitor 600 comprises a collecting unit 610, a receiving unit 620, a detecting unit 630 and a sending unit 640. The collecting unit 610 is configured to collect data indicative of performance status of RIs in a resource pool, the resource pool comprising RIs belonging to two or more different infrastructure providers registered with the cloud platform. The receiving unit 620 is configured to receive, from a resource coordinator 500 in the cloud platform, a subscription request for change notifications indicative of a change in the performance status of the RIs in the resource pool. The detecting unit 630 is configured to detect a change in the performance status of one or more of the RIs in the resource pool. The sending unit 640 is configured to send, to the resource coordinator 500, a change notification, responsive to the change in the performance status.

FIG. 18 is an inventory manager 650 in a cloud platform comprising resources instances spread over multiple infrastructure providers. In one embodiment, the inventory manager 650 comprises a registration unit 660, a receiving unit 670, a detecting unit 680 and a sending unit 690. The registration unit 660 is configured to maintain a register of resources instances in a resource pool available to the cloud platform. The resource pool comprises RIs belonging to two or more different infrastructure providers registered with the cloud platform. The receiving unit 670 is configured to receive, from a resource coordinator 500 in the cloud platform, a subscription request for change notifications indicative of a change in composition of the resource pool. The detecting unit 680 is configured to detect a change in the composition of the resource pool. The sending unit 690 is configured to send, to the resource coordinator 500, a change notification responsive to the change in the composition of the resource pool. The change notification includes a change indicator indicating a change type.

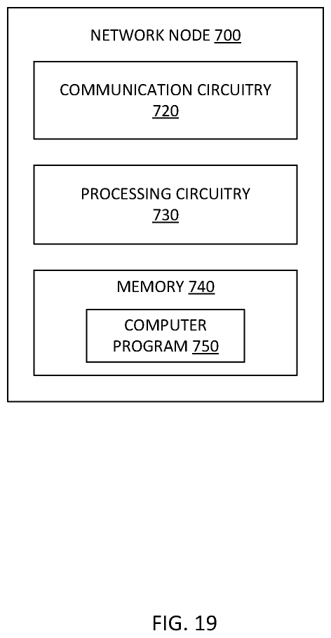

FIG. 19 illustrates the main functional components of a network device 700 that can be configured as a resource coordinator 500, service monitor 600 or inventory manager 650 in a cloud platform, or as a master node 550 in a distributed computing system. The network device 700 can be configured to implement the procedures and methods as herein described. The network device 700 comprises communication circuitry 720, processing circuitry 630, and memory 640.

The communication circuitry 720 comprises network interface circuitry for communicating with other network devices (e.g., K8master nodes 550, OECP-SO, OECP-SM, OECP-IM, etc.) over a communication network, such as an Internet Protocol (IP) network.

Processing circuitry 730 controls the overall operation of the network device 700 and is configured to implement the method shown in FIG. 11 (in the case of a resource controller) or the method of FIG. 12 (in the case of a K8-master node 550). The processing circuitry 730 may comprise one or more microprocessors, hardware, firmware, or a combination thereof configured to perform methods 300, 350, 400 or 450 shown in FIGS. 11-14 respectively.

Memory 740 comprises both volatile and non-volatile memory for storing computer program code and data needed by the processing circuitry 730 for operation. Memory 740 may comprise any tangible, non-transitory computer-readable storage medium for storing data including electronic, magnetic, optical, electromagnetic, or semiconductor data storage. Memory 740 stores a computer program 750 comprising executable instructions that configure the processing circuitry 730 to implement the method shown in FIG. 9. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 750 for configuring the processing circuitry 730 as herein described may be stored in a removable memory, such as a portable compact disc, portable digital video disc, or other removable media. The computer program 750 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

The orchestration platform as herein described provides the flexibility to distribute the worker nodes 70 among different infrastructure providers. The orchestration platform enables more efficient use of physical devices and higher return on investment for the infrastructure providers. End users benefit by having access to more reliable services and a better user experience.

1-61. (canceled)

62. A method implemented by a resource coordinator in a cloud platform of coordinating distribution of resource instances belonging to different infrastructure providers, the method comprising:
determining a pool of resource instances belonging to two or more different infrastructure providers registered with the cloud platform;
distributing the resource instances in the pool among two or more master nodes controlled by the cloud platform to define two or more clusters, each cluster including a respective one of the master nodes and at least one resource instance from the pool supervised by the master node for the cluster; and
wherein at least one cluster comprises two or more resources instances from the pool belonging to different infrastructure providers.

63. The method of claim 62, wherein determining a pool of resource instances belonging to two or more different infrastructure providers registered with the cloud platform comprises receiving inventory information from an inventory manager, the inventory information indicating the resource instances belonging to two or more different infrastructure providers and locations of the resource instances.

64. The method of claim 63, further comprising:
subscribing with the inventory manager to receive change notifications related to changes in the pool of resource instances;
receiving, according to the subscription, a change notification from the inventory manager indicative of a change in the pool of resources; and
redistributing one or more resource instances responsive to the change notification.

65. The method of claim 62, wherein distributing the resources instances in the pool is based at least in part on the locations of the resource instances, available capacities of the resource instances, capabilities of the resource instances, or a combination thereof.

66. The method of claim 62, wherein distributing resource instances from the pool further comprises, reassigning one or more of the resource instances from a current cluster to which the resource instance is currently assigned to a target cluster to which the resource instance is reassigned.

67. The method of claim 65, wherein, reassigning one or more of the resource instances comprises at least one of:
reassigning two or more resource instances belonging to the same infrastructure provider and in the same current cluster to the same target cluster;
reassigning two or more resource instances belonging to different infrastructure providers and in the same current cluster to the same target cluster;
reassigning two or more resource instances belonging to the same infrastructure provider and in the same current cluster to different target clusters; or
reassigning two or more resource instances belonging to different infrastructure providers and in the same current cluster to different target clusters.

68. The method of claim 62, further comprising:
subscribing with a service monitor to receive notifications related the performance status of resources instances in the resources pool;
receiving a status notification from the service monitor indicating a performance status of one or more resource instances in the resource pool; and
responsive to the status notification, redistributing one or more resource instances in the resource pool.

69. The method of claim 62, further comprising:
determining a number of resource instances; and
dynamically deploying the master nodes based on the number of resource instances.

70. A method implemented by a master node in a distributed computing system for managing a cluster of resource instances selected from a resource pool spanning multiple infrastructure providers, the method comprising:
creating a plurality of pods for running application containers; and
distributing the plurality pods among a cluster of resource instances selected from a resource pool comprising a plurality of resource instances spanning multiple infrastructure providers, wherein the cluster comprises resource instances from at least two different infrastructure providers.

71. A method implemented by a service monitor in a cloud platform of monitoring resource instances belonging to different infrastructure providers, the method comprising:
collecting data indicative of performance status of resource instances in a resource pool, the resource pool comprising resource instances belonging to two or more different infrastructure providers registered with the cloud platform;
receiving, from a resource coordinator in the cloud platform, a subscription request for status notifications indicative of the performance status of the resource instances in the resource pool;
detecting a change in the performance status of one or more of the resource instances in the resource pool; and
sending, to the resource coordinator, a status notification, responsive to the change in the performance status.

72. A method implemented by an inventory manager in a cloud platform of monitoring resource instances belonging to different infrastructure providers, the method comprising:
maintaining a register of resources instances in a resource pool available to the cloud platform, the resource pool comprising resource instances belonging to two or more different infrastructure providers registered with the cloud platform;
receiving, from a resource coordinator in the cloud platform, a subscription request for change notifications indicative of a change in composition of the resource pool;
detecting a change in the composition of the resource pool; and
sending (490), to the resource coordinator, a change notification responsive to the change in the composition of the resource pool, the change notification including a change indicator indicating a change type.

73. A resource coordinator in a cloud platform for coordinating distribution of resource instances belonging to different infrastructure providers, the resource coordinator comprising:
communication circuitry for communicating over a communication network with master nodes of a distributing computing system; and
processing circuitry configured to:
determine a pool of resource instances belonging to two or more different infrastructure providers registered with the cloud platform;
distribute the resource instances in the pool among two or more master nodes controlled by the cloud platform to define two or more clusters, each cluster including a respective one of the master nodes and at least one resource instance from the pool supervised by the master node for the cluster; and
wherein at least one cluster comprises two or more resources instances from the pool belonging to different infrastructure providers.

74. The resource coordinator of claim 73, wherein the processing circuitry is further configured to receive inventory information from an inventory manager, the inventory information indicating the resource instances belonging to two or more different infrastructure providers and locations of the resource instances.

75. The resource coordinator of claim 74, wherein the processing circuitry is further configured to:
subscribe with the inventory manager to receive change notifications related to changes in the pool of resource instances;
receive, according to the subscription, a change notification from the inventory manager indicative of a change in the pool of resources; and
redistribute one or more resource instances responsive to the change notification.

76. The resource coordinator of claim 73, wherein the processing circuitry is configured to distribute the resources instances in the pool is based at least in part on the locations of the resource instances, available capacities of the resource instances, or capabilities of the resource instances, or some combination thereof.

77. The resource coordinator of claim 73, wherein the processing circuitry is configured to reassign one or more of the resource instances from a current cluster to which the resource instance is currently assigned to a target cluster to which the resource instance is reassigned.

78. The resource coordinator of claim 77, wherein, reassigning one or more of the resource instances comprises at least one of:
reassigning two or more resource instances belonging to the same infrastructure provider and in the same current cluster to the same target cluster;
reassigning two or more resource instances belonging to different infrastructure providers and in the same current cluster to the same target cluster;
reassigning two or more resource instances belonging to the same infrastructure provider and in the same current cluster to different target clusters; or reassigning two or more resource instances belonging to different infrastructure providers and in the same current cluster to different target clusters.

79. The resource coordinator of claim 62, wherein the processing circuitry is configured to:
subscribe with a service monitor to receive notifications related the performance status of resources instances in the resources pool;
receive a status notification from the service monitor indicating a performance status of one or more resource instances in the resource pool; and
responsive to the status notification, redistribute one or more resource instances in the resource pool.

80. The resource coordinator of claim 62, wherein the processing circuitry is configured to:
determine a number of resource instances; and
dynamically deploy the master nodes based on the number of resource instances.
